(19) United States
(12) Patent Application Publication
(10) Pub. No.: US 2002/0161709 A1
(43) Pub. Date: Oct. 31, 2002

(54) SERVER-SIDE COMMERCE FOR DELIVER-THEN-PAY CONTENT DELIVERY

(76) Inventors: MICHEL FLOYD, REDWOOD CITY, CA (US); CAY S. HORSTMANN, CUPERTINO, CA (US); RON E. LUNDE, PORTLAND, OR (US)

Correspondence Address: BURNS DOANE SWECKER & MATHIS L L P, POST OFFICE BOX 1404, ALEXANDRIA, VA, 22313-1404, US

(21) Appl. No.: 09/151,296

(22) Filed: Sep. 11, 1998

(51) Int. Cl. G06F 17/60

(52) U.S. Cl. 705/51

(57) ABSTRACT

The present invention, generally speaking, provides a flexible mechanism for effecting a payment/unlock transaction for deliver-then-pay content distribution. Instead of interacting with a local client interface, purchase is effected by interacting with a commerce Web site. The content is unlocked by delivering to the client a certificate, which serves as proof of purchase. The certificate is rendered secure so that it cannot simply be replicated to gain additional unauthorized access. In a preferred embodiment, a local application (e.g., a stand-alone application or a browser plug-in) is present on the end-user's machine and is registered with the local operating system and browser to handle files of a particular type used for certificates. Downloading and processing of the certificate may therefore be done transparently, without user-intervention. Piracy is prevented by “individuation” of the certificate. If the certificate simply unlocked the product, then nothing would prevent that certificate from simply being moved to any number of other machines or used by multiple unauthorized users. To prevent this, certificate individuation is performed. Preferably, the certificate is generated in a unique manner when it is first provided to the consumer. Alternatively, the first time a certificate is processed on an end-user machine, the certificate together with unique local machine information (such as the hard drive ID) and/or unique user information (e.g., biometric information such as fingerprint information, information from a smart card, etc.) is then presented back to the server (either the original server or a separate reference server) for validation. The server can therefore control how many times a certificate is used.

### BACKGROUND OF THE INVENTION

1. Field of the Invention

The present invention relates to deliver-then-pay distribution of electronic content, e.g., software, images, sounds, etc.

2. State of the Art

Internet commerce continues to experience explosive growth. Internet commerce is especially well-suited to the delivery of electronic content, e.g, software, images, sounds, etc. However, electronic content distribution (ESD, a subset of which is electronic software distribution, or ECD), poses particular difficulties due to attempted misappropriation, i.e., software piracy. Two different models of ECD are pay-then-deliver and deliver-then-pay. Related but somewhat different terms applied to ECD are “Buy-Before-You-Try” (Buy/Try) and “Try-Before-You-Buy” (Try/Buy). Try/Buy ECD technology, as the name suggests, allows a potential customer to try a piece of software (or other electronic content) before deciding whether or not to purchase the software. A limited trial period is allowed. In this instance, the piece of software (or data) has already been delivered to the consumer but is still protected (e.g., encrypted) and needs to be “purchased” (rented, leased, etc.) in order to be unlocked for a longer duration and therefore be useful for the consumer.

Existing Try/Buy purchase mechanisms are client-based and rely on capturing the consumer's credit data (e.g., credit card number, billing address) on the consumer's machine and transmitting this information to a server to validate the credit data and execute the purchase transaction. The server then returns an “unlock code” or “decryption key.” This approach is used by a Vbox™ ECD product of the present assignee as well as other products within the same category from such vendors as TechWave, Release Software, and Ziplock. The foregoing approach, however, is inflexible. For example, typically only credit cards are supported. The currency is restricted to those supported in the client. Furthermore, absent a mechanism to allow price lookup to be done during a transaction, the product price must be “hard-wired” into the product before it is downloaded.

Other ECD mechanisms have used certificates to allow a product to be downloaded. Ziplock's Zert™ certificate is fetched by the client upon completion of a purchase transaction. Cybersource's Sm@rtCert™ is an X.509 certificate that includes merchandising information and a URL that allows a product to be downloaded. However, both these models support only pay-then-deliver (i.e., the “certificate” provides the capability to download the product) and do not support Try/Buy.

Other types of payment and delivery mechanisms, both present and future, may be expected to strain the capabilities of current systems. Distribution may not be by electronic download but may be by CD or the like, which most current distribution models are ill-equipped to handle. Also, a Web-based electronic wallet system is currently under development to reduce credit card fraud. The ability to achieve compatibility with such an electronic wallet system relatively painlessly is much to be desired.

What is needed is a more flexible mechanism for effecting a payment/unlock transaction for deliver-then-pay content distribution.

### SUMMARY OF THE INVENTION

The present invention, generally speaking, provides a flexible mechanism for effecting a payment/unlock transaction for deliver-then-pay content distribution. Instead of interacting with a local client interface, purchase is effected by interacting with a commerce Web site. The content is unlocked by delivering to the client a certificate, which serves as proof of purchase. The certificate is rendered secure so that it cannot simply be replicated to gain additional unauthorized access. In a preferred embodiment, a local application (e.g., a stand-alone application or a browser plug-in) is present on the end-user's machine and is registered with the local operating system and browser to handle files of a particular type used for certificates. Downloading and processing of the certificate may therefore be done transparently, without user-intervention. Piracy is prevented by “individuation” of the certificate. If the certificate simply unlocked the product, then nothing would prevent that certificate from simply being moved to any number of other machines or used by multiple unauthorized users. To prevent this, certificate individuation is performed. Preferably, the certificate is generated in a unique manner when it is first provided to the consumer. Alternatively, the first time a certificate is processed on an end-user machine, the certificate together with unique local machine information (such as the hard drive ID) and/or unique user information (e.g., biometric information such as fingerprint information, information from a smart card, etc.) is then presented back to the server (either the original server or a separate reference server) for validation. The server can therefore control how many times a certificate is used.

### BRIEF DESCRIPTION OF THE DRAWING

The present invention may be further understood from the following description in conjunction with the appended drawing. In the drawing:

FIG. 1 is a block diagram of a system in which the present invention may be used;

FIG. 2 is a “buy me” screen display produced by the usage rights acquisition interface control of FIG. 1;

FIG. 3 is a “shopping cart” screen display;

FIG. 4 is a block diagram illustrating an electronic payment transaction and delivery of a certificate evidencing usage rights;

FIG. 5 is a block diagram illustrating an electronic payment transaction during which binding information is uploaded from the end-user machine and delivery of a certificate incorporating binding information;

FIG. 6 is a block diagram illustrating tender of a serialized, unbound certificate, together with binding information and delivery of a certificate incorporating binding information;

FIG. 7 is a block diagram illustrating certificate validation processing options;

FIG. 8 is a block diagram showing a single-server system in which the present invention may be used; and

FIG. 9 is a block diagram of a multiple-server system in which the present invention may be used.

### DETAILED DESCRIPTION OF THE PREFERRED EMBODIMENTS

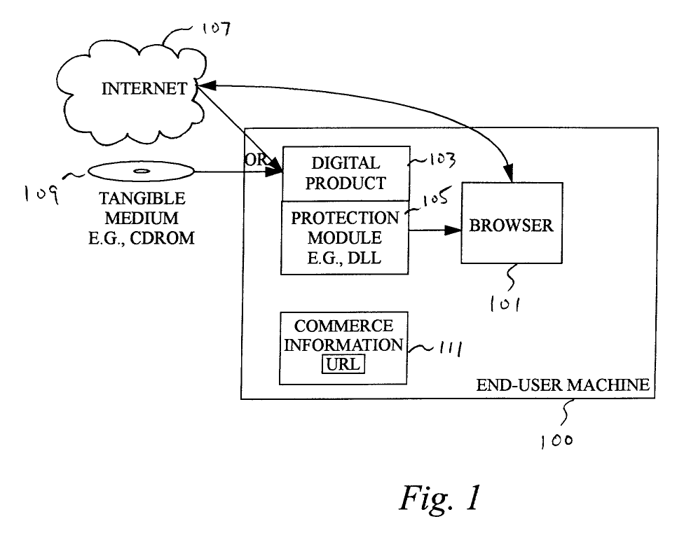

Referring now to FIG. 1, a block diagram is shown of a system in which the present invention may be used. An end-user machine 100 is shown as including a browser 101 or similar program that interfaces with a server location and enables the user to request the granting of usage rights. A digital product 103 and an associated protection module 105 are delivered to the end-user machine, either on-line, e.g., through a computer network 107 such as the Internet, or off-line, e.g., through a tangible medium 109 such as a computer hard drive, CD-ROM, etc. The protection module may take the form of code “injected” into the product for example, using techniques practised in the art or as described more fully in co-pending U.S. patent application ______ (Atty. Dkt. 031994-003), incorporated herein by reference. The protection module may take the form of a Dynamic Link Library (DLL). Alternatively, the protection module may take the form of API calls inserted into the original source code of a software program. Still other types of protection modules will be apparent to one of ordinary skill in the art. For example, the protection module may be part of a Try/Buy software application or a plug-in for a browser or other application having a plug-in architecture. The protection module may be a program that conditionally decrypts content and interfaces with off-the-shelf software (e.g., Microsoft Word™, Adobe Acrobat™, etc.).

Besides the protection module, also associated with the digital product is commerce information 111, typically including a server location (URL). The commerce information may be stored as part of or apart from the digital product or protection module. The product, the protection module and the commerce information may be installed on or stored on the user machine together during a single overall operation or separately. In one embodiment, the product, the protection module and the commerce information are downloaded as a single installation-ready package and installed together.

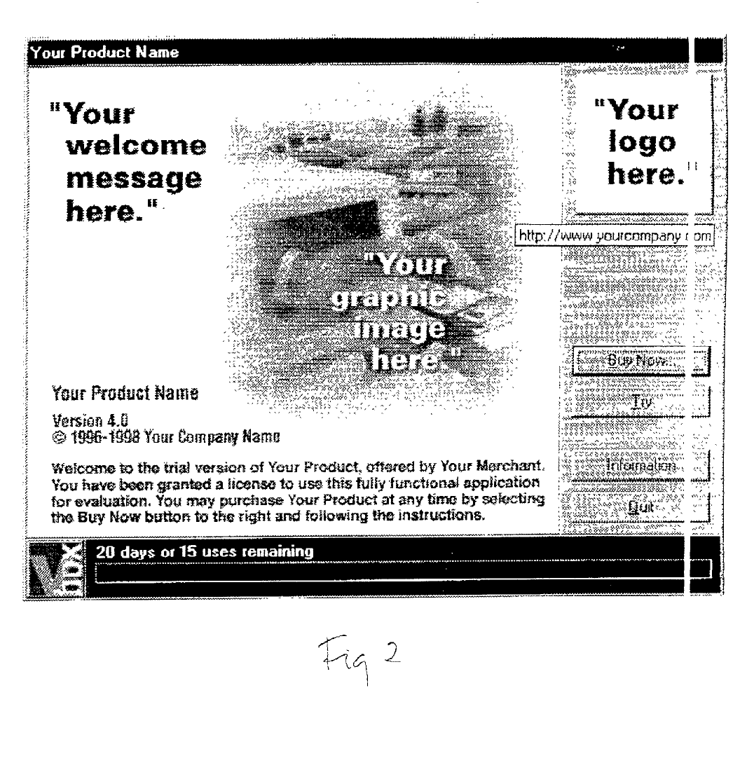

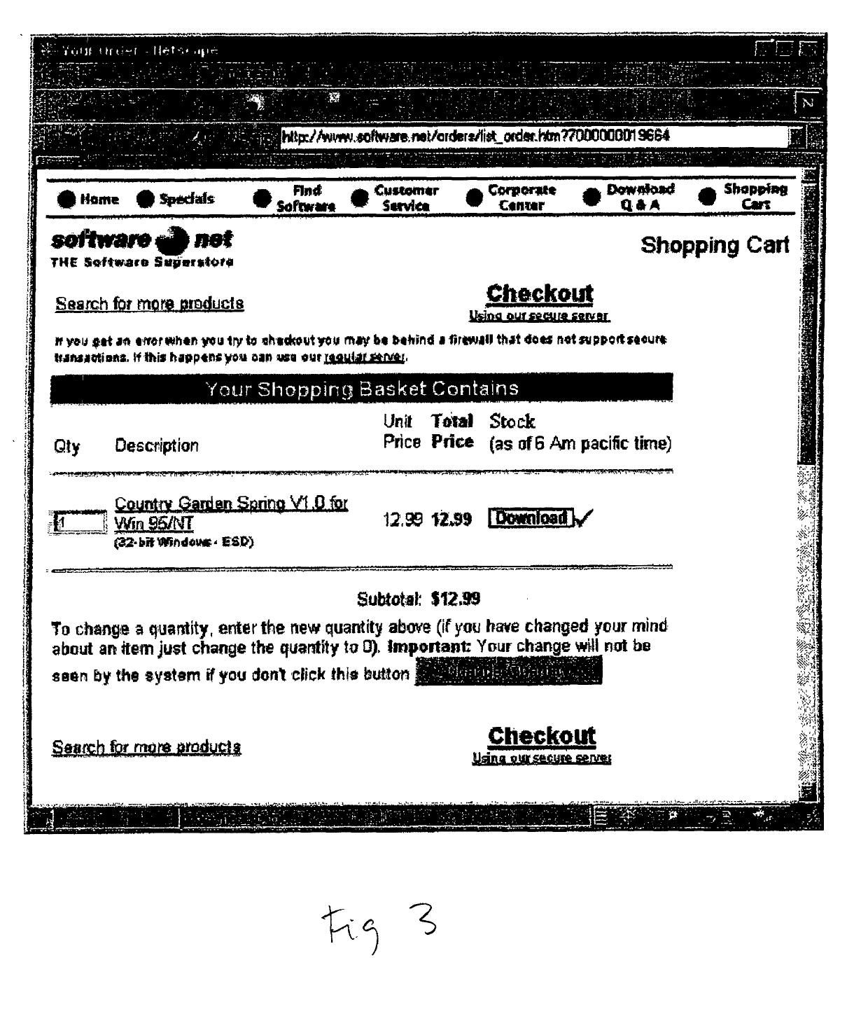

When use of the product is attempted, the protection module determines whether such use is authorized. In the case of Try/Buy ECD, for example, a 30-day free trial may be allowed. The protection module displays to the user trial status information (e.g., 10 days remaining, 5 uses remaining, etc.). The protection module also displays a user interface control for buying additional use of the product (FIG. 2). A purchase transaction is carried out by a commerce system running on the server. As part of this transaction, an off-the-shelf viewer such as a Web browser or a custom viewer program retrieving presentation information from the server displays a page such as that of FIG. 3 is displayed to the user, ultimately instructing the user to click on a “Get Certificate” link having a particular MIME type.

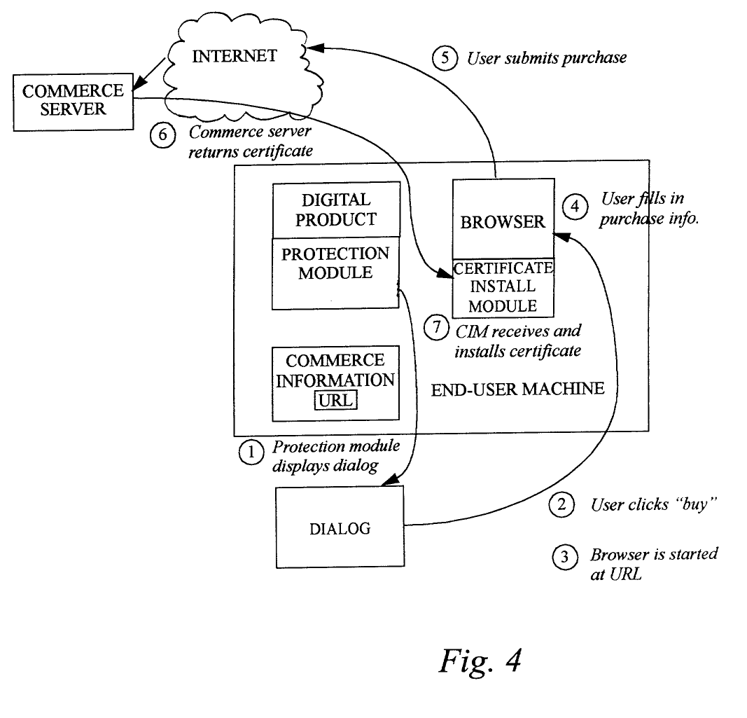

Referring more particularly to FIG. 4, the protection module first displays a dialog to the user (Step 1). When the user activates the user interface control (clicks “buy,” Step 2), the following sequence of events ensues. The protection module uses the browser to access the commerce information stored on the user machine. The commerce information designates a server that includes transaction processing software and either includes or is network-connected to a certificate database. The browser is started at the server URL (Step 3), and the server presents to the user a Web page used to provide purchase information. The user completes the Web page by filling in purchase information (Step 4) and submits it to the server (Step 5). A purchase transaction is then carried out using known methods of electronic commerce. Various known security mechanisms may be used during transaction processing, e.g., Secure Socket Layer (SSL), Secure Electronic Transaction (SET), etc. Furthermore, payment may be effect in any manner supported by the server. Whereas credit cards are typically used for consumer transactions, other types of transactions may use purchase orders, corporate lines of credit, etc. If the browser supports electronic wallets, then this capability can automatically be taken advantage of for purchase transactions.

Referring still to FIG. 4, if transaction processing is successful, then a certificate is downloaded to the user machine (Step 6). The certificate may be a file of a specific type, for example. The certificate will typically contain a rights statement of some type and will be secured using a tamperproof mechanism. For example, the certificate may be encrypted such that a hacker cannot tell how to alter the certificate to accomplish the hacker's purpose, or the certificate may be signed using a digital signature such that any tampering may be readily detected. The rights statement may vary depending on implementation. For example, the rights statement may simply be the name of the digital product, purchase of the product being implied. Alternatively, the rights statement may entitle the user to use the digital product for a limited period of time, a limited number of uses, etc.

At the user machine, a predetermined certificate installation module optionally receives and installs the certificate (Step 7). The certificate installation module may be a plug-in, an Active X control, a MIME type handler, or other mechanism to automatically process the certificate data and may be registered with the browser to handle files of that specific type. The module may be the protection module or some other module. Alternatively, the certificate may come appended to an executable program that the user then executes. When the program executes, it stores the certificate in the correct place for the protection module to later find it. Of course, there may be no module or program provided to handle the certificate and store in the correct place. In this instance, the user is required to store the certificate in the correct place. Preferably, however, the user is shielded from this detail by one of the former mechanisms, resulting in a more pleasant user experience.

The foregoing process in accordance with an exemplary embodiment may be summarized as follows:

1. The protection module ensures that a certificate installation program for installing the certificate is registered with the browser (i.e., as a handler for certificate files as represented by a particular MIME type) or otherwise installs the program.

2. The protection module launches the browser to go to the purchase URL. The protection module may also send to the server via the browser local information such as binding information.

3. A purchase transaction is carried out by a commerce system running on the server. As part of this transaction, a Web page such as that of FIG. 3 is displayed to the user instructing the user to click on a “Get Certificate” link having the particular MIME type previously mentioned.

4. The user clicks on the link.

5. The certificate installation program receives and installs the certificate.

If it is desired to prevent transfer of the certificate to another machine or user, “individuation” of certificates may be performed. Individuation allows verification to be performed prior to allowing use of the digital product. Two possibilities of such verification will be described hereafter.

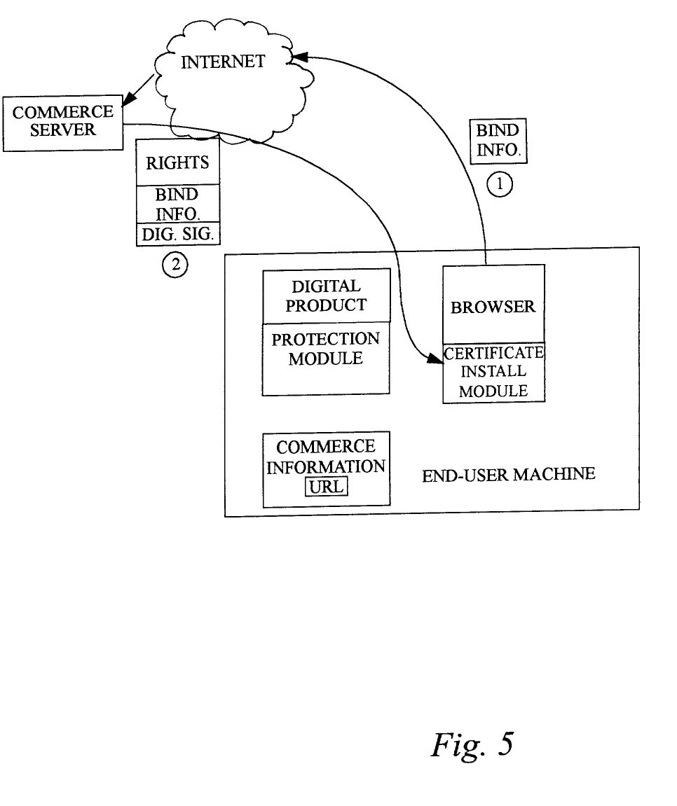

Individuation may occur prior to download of the certificate or after download of the certificate. Furthermore, various different kinds of individuation may be performed including, for example, one-step binding individuation and two-step binding individuation. In one-step binding, binding information identifying a particular machine or a particular user is sent to the server and added to the certificate, after which the certificate is digitally signed and downloaded to the end-user machine (FIG. 5). In the case of machine binding, the binding information is derived from the hardware and/or software of the user machine. For example, hardware binding information may come from a hard disk ID, a network card unique ID, IDs derived from plug-in cards, processor type, and so on. In the case of user binding, the binding information may be an ID derived from a fingerprint, a smartcard, a user-chosen password, etc., or some combination of the foregoing.

In some instances, one-step binding is problematic. In the case of user binding based on fingerprints, for example, the binding information may be quite large. It may be difficult to cause the browser to transport a large amount of binding information up to the server. Similarly, where the server functionality is distributed among multiple servers, it may be difficult to cause a commerce system to transport a large amount of information to a certificate issuer server.

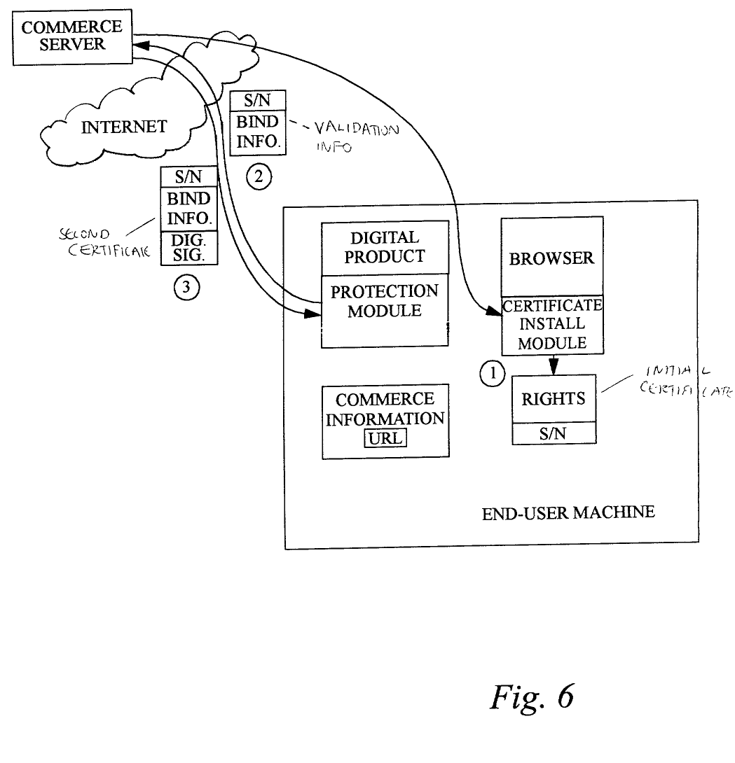

The foregoing difficulties may be overcome using two-step binding. In two-step binding, the first step involves sending a serialized certificate. Referring to FIG. 6, the second step involves trading the serialized certificate for a bound certificate. To avoid a replay attack, some mechanism is required on the server side to keep track of which serialized certificates have been traded in this fashion. A protection module, instead of connecting to the server through a browser, may establish a direct connection, allowing for the exchange of data of arbitrary length. Similarly, communication between a merchant Web site and a certificate issuer Web site (if separate from the merchant Web site) may be handled without involvement of the commerce system, or “storefront,” of the merchant Web site.

As has been described, certificate individuation may be performed in may different ways. Verification may also be performed in many different ways. Verification requires secure storage in order to store information needed to positively identify a particular certificate. Secure storage may be located on-and hence verification may be performed at-the server machine, the client machine, or both. Each alternative has its relative advantages and relative disadvantages. Server validation is most secure but also requires a large amount of central storage and a permanent connection of the client machine to the server. Client validation is less secure but does not require a large amount of central storage or permanent connection of the client machine to the server. A combination of server and client validation provides a lesser degree of security than server validation but requires only intermittent connection of the client machine to the server. Server validation and combined server/client validation may involve periodic reissuance or revalidation of the certificate. For example, using server validation, if a certificate gives the right for some number of uses of the digital product, then each time the digital product is used, the old certificate may be traded for an update certificate containing within the certificate itself the number of uses remaining.

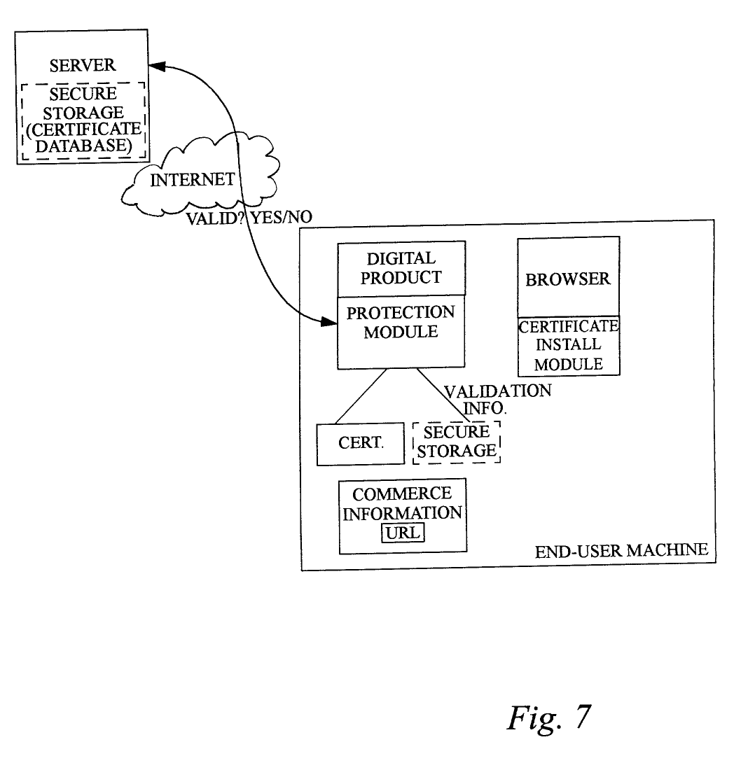

Referring to FIG. 7, when the user attempts to use the product, the protection module looks to see whether a certificate for the product is stored on the user machine. If so, the protection module proceeds to validate the stored certificate, either on-line by connecting to the server through the browser or off-line locally. If on-line, the certificate is presented to the server. The server validates the certificate by checking in the certificate database whether or not the particular certificate being presented has been presented previously and whether further presentations are allowed. An entry is updated in the certificate database that keeps track of the number of times the particular certificate has been presented. If the certificate limits are met, a message or a second certificate is sent back to the protection module on the user machine validating the certificate and authorizing use based on the certificate for the duration of the certificate period. If the server finds that the particular certificate has already been presented the maximum number of times (or more), then the server invalidates the certificate and instructs the protection module to not allow the product to be used based on the certificate.

Validation requirement may vary from “validate once” to “validate always.” For example, if initial validation is successful, the protection module may then store an indication that the product is “paid up.” The next time use of the product is attempted, the protection module may allow use without checking with the server. Alternatively, validation may be required every use, every N-th use, or at periodic time intervals.

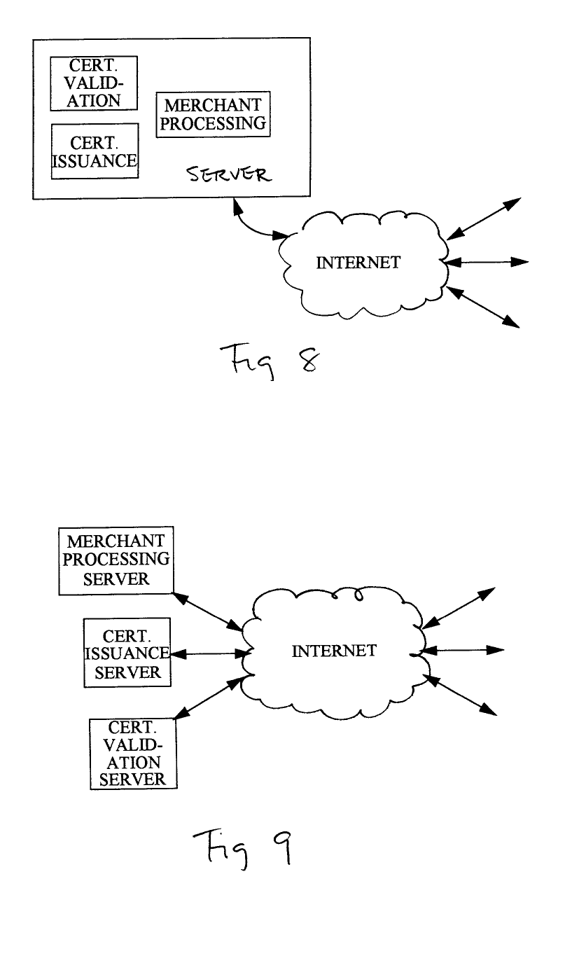

It should be noted that the present invention may be used in systems having centralized server-side functionality and in systems having greater or lesser degrees of distributed server-side functionality. Referring to FIG. 8, for example, a single server performs payment processing, certificate issuance and certificate validation. Referring to FIG. 9, on the other hand, each of these functions is performed by a separate server.

It will be appreciated by those of ordinary skill in the art that the invention can be embodied in other specific forms without departing from the spirit or essential character thereof. The presently disclosed embodiments are therefore considered in all respects to be illustrative and not restrictive. The scope of the invention is indicated by the appended claims rather than the foregoing description, and all changes which come within the meaning and range of equivalents thereof are intended to be embraced therein.

What is claimed is:

1. A deliver-then-pay method of electronic content distribution, comprising the steps of:
providing as part of a digital product a usage rights acquisition interface control and a server location for rights acquisition;
providing on a server location presentation and business logic for usage rights acquisition; and
users of the digital product using the usage rights acquisition interface control to activate a program that interacts with the server location.

2. The method of claim 1 where said activated program is a web browser interacting with a web server.

3. The method of claim 1 where said activated program interacts with the server location to cause the user to pay for usage rights by supplying payment information.

4. The method of claim 1 where said activated program interacts with the server location to cause the user to supply a commitment to pay for usage rights by supplying proof of identity and commitment information.

5. The method of claim 1 where said activated program offers the user a choice of payment currencies.

6. The method of claim 1 where said activated program interacts with the server location to cause the user to supply a proof of prior authorization for usage rights.

7. The method of claim 1 where activation of said program interacting with the server location causes transmittal of local information to the server location without requiring user interaction.

8. The method of claim 7 where said local information contains binding information related to the user's computer system.

9. The method of claim 7 where said local information contains user identity information.

10. The method of claim 9 where said user identity information contains biometric information.

11. The method of claim 9 where said user identity information contains smartcard information.

12. The method of claim 7 where said local information contains payment information.

13. The method of claim 7 where said local information contains information on desired usage rights.

14. The method of claim 7 where said local information contains information on existing usage rights.

15. The method of claim 7 where said local information contains a unique identification number.

16. The method of claim 1, further comprising the step of the server location returning a usage rights certificate.

17. The method of claim 16, comprising the further step of the activated program causing a certificate installation module that is present on the user machine to process said usage rights certificate.

18. The method of claim 16, wherein the digital product includes a protection module, the method comprising of the further step of using information contained in the usage rights certificate to cause the protection module to permit or deny usage of said digital product.

19. The method of claim 16, wherein the server embeds individuation data in the certificate.

20. The method of claim 16 where said individuation data contains binding information related to the user's computer system.

21. The method of claim 16 where said individuation data contains user identity information.

22. The method of claim 21 where said user identity information contains biometric information.

23. The method of claim 21 where said user identity information contains smartcard information.

24. The method of claim 16 where said individuation data contains information on usage rights.

25. The method of claim 16 where said individuation data contains a unique identification number.

26. The method of claim 16, where the certificate is digitally signed.

27. The method of claim 16, further comprising performing local validation of the certificate on the user's computer system based on individuation data and local information.

28. The method of claim 16, further comprising establishing a network connection and presenting validation information to a server.

29. The method of claim 28, wherein said validation information contains individuation data.

30. The method of claim 28, wherein said validation information contains local information.

31. The method of claim 28, wherein the server performs validation of the validation information and returns the result of said validation.

32. The method of claim 28, wherein the server performs validation of the validation information and upon successful validation returns a new certificate.

33. The method of claim 32, wherein said new certificate has the same structure as the old certificate.

34. The method of claim 32, wherein said new certificate has a different structure than the old certificate.

35. The method of claim 28, wherein the server records validation events.

36. The method of claim 35, wherein server validation is dependent on the frequency of validation events.

37. The method of claim 35, wherein server validation is dependent on the user's fulfillment of payment commitment.

38. The method of claim 27, wherein the user's computer system records validation events.

39. The method of claim 38, wherein local validation is dependent on the frequency of validation events.

40. The method of claim 28, wherein the server performs validation of the validation information and upon successful validation returns at least one additional digital product.
